(19) United States
(12) Patent Application Publication
(10) Pub. No.: US 2013/0141865 A1
(43) Pub. Date: Jun. 6, 2013

(54) HEAT DISSIPATION SYSTEM

(71) Applicants: Kang Wu, Shenzhen City (CN); Bo Tian, Shenzhen City (CN)

(72) Inventors: Kang Wu, Shenzhen City (CN); Bo Tian, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/597,569

(22) Filed: Aug. 29, 2012

(30) Foreign Application Priority Data
Dec. 3, 2011 (CN) 201110395478.5

(51) Int. Cl. G06F 1/20

(52) U.S. Cl. 361/679.33; 361/679.49; 361/679.31

(57) ABSTRACT

An exemplary heat dissipating system includes a case, a motherboard, an air conducting guide dividing the motherboard into a first area and a second area, a group of first fans, and a group of second fans. The group of first fans and the group of second fans draw cool air into the first area and the second area from different directions for dissipating heat generated by electronic components on the motherboard.

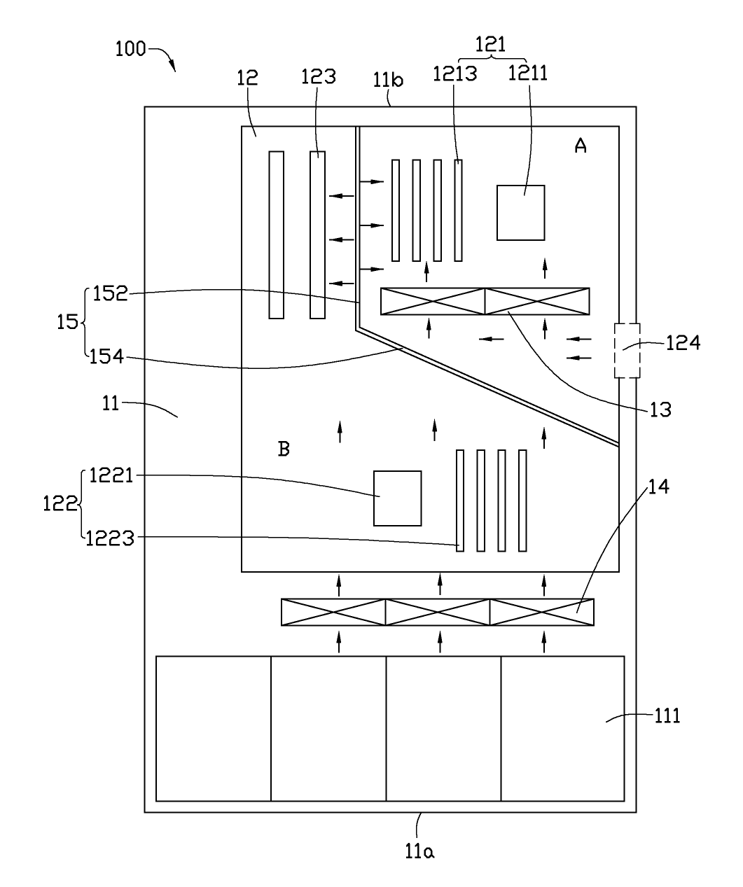

### BACKGROUND

1. Technical Field

The disclosure generally relates to heat dissipation systems, and particularly to a heat dissipation system for improving heat dissipation efficiency of an electronic device.

2. Description of the Related Art

To enhance functions of a motherboard in an electronic device, such as a computer, or a server, for example, more than two central processing units (CPUs) may be applied to the motherboard. A typical heat dissipation system for the CPUs and other components of the motherboard includes two fans aligned with each other. In use, the cool air from outside of the electronic device is sucked into the electronic device by one of the fans, and absorbs the heat generated by the CPUs and other components of the motherboard. The heated air is further collected by the other fan and mainly flows towards the motherboard. Thus, a temperature of the motherboard is greatly increased and will cause the CPUs and other components of the motherboard to be potentially damaged, thereby affecting a reliability of the heat dissipation system.

Therefore, there is room for improvement within the art.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several diagrams. Wherever possible, the same reference numbers are used throughout the drawings to refer to the same or like elements of an embodiment.

The FIGURE is a schematic diagram of a heat dissipation system, according to an exemplary embodiment.

### DETAILED DESCRIPTION

The FIGURE is a schematic diagram of a heat dissipation system 100, according to an exemplary embodiment. The heat dissipation system 100 may be applied to an electronic device, such as a computer, or a server, for example, and includes a case 11, a motherboard 12, a group of first fans 13, a group of second fans 14 and an air conducting guide 15. The case 11 includes a first sidewall 11a and a second sidewall 11b opposite to the first sidewall 11a. A group of hard disk drives (HDDs) 111 are positioned in the case 11 adjacent to the first sidewall 11a of the case 11. The motherboard 12 is positioned in the case 11 adjacent to the second sidewall 11b of the case 11 and faces to the group of HDDs 111. The group of first fans 13 and the group of second fans 14 draw cool air into the motherboard 12 from different directions for dissipating heat generated by electronic components on the motherboard 12.

The motherboard 12 has a first heat source 121, a second heat source 122, and a third heat source 123 attached. The first heat source 121 is positioned on one end of the motherboard 12. The second heat source 122 is positioned on another end of the motherboard 12 and faces to the first heat source 121. The third heat source 123 is positioned on the motherboard 12 adjacent to the first heat source 121. An airflow inlet opening 124 is defined on one side of the motherboard 12 adjacent to the first heat source 121, and communicates with the cool air outside of the electronic device. In one embodiment, the first heat source 121 includes a first central processing unit (CPU) 1211 and a first memory module 1213. The second heat source 122 includes a second CPU 1221 and a second memory module 1223. The third heat source 123 includes a plurality of peripheral component interconnect (PCI) slots installed with corresponding PCI devices (not shown).

The group of first fans 13 are secured on the motherboard 12 adjacent to first heat source 121 and can draw cool outside air (e.g., cool air outside of the electronic device) from the airflow inlet opening 124 into the motherboard 12 for dissipating heat generated by the first heat source 121.

The group of second fans 14 are positioned between the group of HDDs 111 and the motherboard 12, and can draw the cool outside air from the HDDs 111 into the motherboard 12 for dissipating heat generated by the second heat source 122 and the third heat source 123.

The air conducting guide 15 is positioned on the motherboard 12 and divides the motherboard 12 into a first area A and a second area B. In detail, the first heat source 121 and the group of first fans 13 are positioned in the first area A. The second heat source 122 and the third heat source 123 are positioned in the second area B. The air conducting guide 15 includes a first plate 152 and a second plate 154. The first plate 152 is located between the first heat source 121 and the third heat source 123, parallel to a side of the motherboard 12. The second plate 154 extends from an end of the first plate 152 and is located between the group of first fans 13 and the second heat source 122.

The group of first fans 13 direct cool air outside of the electronic device to flow passed the first heat source 121 to form a first airflow path in the first area A, thereby dissipating heat generated by the electronic components in the first area A (i.e., the first heat source 121). The group of second fans 14 direct the cool air to flow passed the second heat source 122 and the third heat source 123 to form a second airflow path in the second area B, thereby dissipating heat generated by the electronic components in the second area B (i.e., the second heat source 122 and the third heat source 123). Furthermore, the cool air outside of the electronic device flowing through the group of first fans 13 will be prevented by the air conducting guide 15 from flowing into the second area B and guided to flow towards the first heat source 121, thereby enhancing dissipation efficiency of the heat dissipation system 100. Similarly, the cool air outside of the electronic device flowing through the group of second fans 14 will be prevented by the air conducting guide 15 from flowing into the first area A and guided to flow towards the second heat source 122 and the third heat source 123, thereby enhancing dissipation efficiency of the heat dissipation system 100.

In use, the group of first fans 13 and the group of second fans 14 are activated to work. The group of first fans 13 draw cool air from outside of the electronic device towards the motherboard 12 via the airflow inlet opening 124 for dissipating heat generated by the first heat source 121. At the same time, the cool air outside of the electronic device flowing through the group of first fans 13 will be guided by the air conducting guide 15 to flow towards the first heat source 121 according to the first airflow path, thereby enhancing dissipation efficiency of the heat dissipation system 100.

Similarly, the group of second fans 14 draw the cool air from outside of the electronic device towards the motherboard 12 via the HDDs 111 for dissipating heat generated by the second heat source 122 and the third heat source 123. Furthermore, the cool air flowing through the group of second fans 14 will be guided by the air conducting guide 15 to flow towards the second heat source 122 and the third heat source 123 according to the second airflow path, thereby enhancing dissipation efficiency of the heat dissipation system 100.

In other embodiments, the heat dissipation system 100 further includes a first heat sink (not shown) positioned on a side of the group of first fans 13 and a second heat sink (not shown) positioned on a side of the group of second fans 14 to further enhance dissipation efficiency of the heat dissipation system 100.

Accordingly, the cool air from outside of the electronic device can be drawn into the motherboard 12 from different directions (i.e., the airflow inlet opening 124 and the HDDs 111), thus, the group of first fans 13 and the group of second fans 14 adopt separate airflow paths/channels and airflow inlets for heat dissipation of the electronic components on the motherboard 12 (e.g., the first heat source 121, the second heat source 122, and the third heat source 123). Therefore, an interference of airflows in the case 11 can be avoided, and a temperature of the motherboard 12 is maintained at a lower temperature.

In the present specification and claims, the word “a” or “an” preceding an element does not exclude the presence of a plurality of such elements. Further, the word “comprising” does not exclude the presence of elements or steps other than those listed.

It is to be also understood that even though numerous characteristics and advantages of exemplary embodiments have been set forth in the foregoing description, together with details of the structures and functions of the embodiments, the disclosure is illustrative only, and changes may be made in detail, especially in matters of arrangement of parts within the principles of this disclosure to the full extent indicated by the broad general meaning of the terms in which the appended claims are expressed.

What is claimed is:

1. A heat dissipating system, comprising:
a case;
a motherboard positioned in the case;
an air conducting guide positioned on the motherboard and dividing the motherboard into a first area and a second area;
a group of first fans positioned in the first area; and
a group of second fans adjacent to the motherboard;
wherein the group of first fans draw cool air from outside of the case in a first direction over the motherboard for dissipating heat generated by electronic components in the first area; the group of second fans draw cool air from outside of the case in a second direction over the motherboard for dissipating heat generated by electronic components in the second area.

2. The heat dissipating system of claim 1, further comprising an airflow inlet opening defined in the first area and communicating with outside of the case, the cool air from the first direction is sucked into the motherboard through the airflow inlet opening.

3. The heat dissipating system of claim 1, wherein the electronic components in the first area comprise a first heat source.

4. The heat dissipating system of claim 3, wherein the first heat source comprises a first central processing unit (CPU) and a first memory module.

5. The heat dissipating system of claim 1, wherein the electronic components in the second area comprise a second heat source and a third heat source.

6. The heat dissipating system of claim 5, wherein the second heat source comprises a second CPU and a second memory module.

7. The heat dissipating system of claim 5, wherein the third heat source comprises a plurality of peripheral component interconnect slots.

8. The heat dissipating system of claim 1, wherein the case comprises a group of hard disk drives (HDDs) facing to the group of second fans, the cool air from the second direction is sucked into the motherboard through the HDDs.

9. A heat dissipating system applied to an electronic device, comprising:
a case;
a motherboard positioned in the case;
an air conducting guide positioned on the motherboard and dividing the motherboard into a first area and a second area;
a first heat source positioned in the first area;
a second heat source positioned in the second area;
a third heat source positioned in the second area adjacent to the first heat source;
a group of first fans positioned in the first area adjacent to the first heat source; and
a group of second fans adjacent to the motherboard and facing to the second heat source;
wherein the group of first fans draw a first cool air into the first area of the motherboard for dissipating heat generated by the first heat source; the group of second fans draw a second cool air into the second area of the motherboard for dissipating heat generated by the second heat source and the third heat source; the air conducting guide prevents the second cool air from flowing into the first area.

10. The heat dissipating system of claim 9, further comprising an airflow inlet opening defined on the motherboard adjacent to the first heat source and communicating with the outside of the electronic device, the first cool air is sucked into the motherboard through the airflow inlet opening.

11. The heat dissipating system of claim 9, wherein the case comprises a group of hard disk drives (HDDs) facing to the group of second fans, the second cool air is sucked into the motherboard through the HDDs.

12. The heat dissipating system of claim 9, wherein the first heat source comprises a first central processing unit (CPU) and a first memory module.

13. The heat dissipating system of claim 9, wherein the second heat source comprises a second CPU and a second memory module.

14. The heat dissipating system of claim 9, wherein the third heat source comprises a plurality of peripheral component interconnect slots.
